(19) United States
(12) Patent Application Publication
(10) Pub. No.: US 2024/0308629 A1
(43) Pub. Date: Sep. 19, 2024

(54) FLOATING LIFT WITH CHARGING SYSTEM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/604,413

(22) Filed: Mar. 13, 2024

Related U.S. Application Data
(60) Provisional application No. 63/451,784, filed on Mar. 13, 2023.
(60) Provisional application No. 63/451,790, filed on Mar. 13, 2023.

(51) Int. Cl. B63B 35/44; B60L 53/16; B60L 53/18; B60L 53/31; B60L 53/36; B60L 53/51; B60L 53/53; B60L 53/68; B63B 21/16

(52) U.S. Cl. CPC B63B 35/44; B60L 53/16; B60L 53/18; B60L 53/31; B60L 53/36; B60L 53/51; B60L 53/53; B60L 53/68; B63B 21/16; B60L 2200/32

(57) ABSTRACT

One or more examples provide an electric vehicle or a device for use with an electric vehicle, including a floating lift having a watercraft charging system.

### CROSS REFERENCE TO RELATED APPLICATION

This Non-Provisional patent application claims the benefit of the filing date of U.S. Provisional Patent Application Ser. No. 63/451,784, filed Mar. 13, 2023 and U.S. Provisional Patent Application Ser. No. 63/451,790, filed Mar. 13, 2023, both of which are herein incorporated by reference.

### TECHNICAL FIELD

The present disclosure relates generally to examples of electric watercraft and to devices for use with an electric watercraft, including electric watercraft batteries and electric watercraft charging systems and devices.

### BACKGROUND

Electric watercraft and electric watercraft devices provide quiet, clean, and efficient powertrains for moving from place to place or having fun on water. When not in use, an electric watercraft can be parked on a floating lift.

For these and other reasons, there is a need for the present invention.

### SUMMARY

The present disclosure provides one or more examples of an electric watercraft and systems and/or devices for use with an electric watercraft. In one or more examples, the system is a floating lift that includes an electric watercraft charging system and/or charging device.

Additional and/or alternative features and aspects of examples of the present technology will become apparent from the following description and the accompanying drawings.

### BRIEF DESCRIPTION OF THE DRAWINGS

The Figures generally illustrate one or more examples of an electric watercraft and/or devices for use with an electric watercraft such as electric watercraft charging systems and devices, including a floating lift with charging system.

FIG. 1 is a diagram generally illustrating a floating lift with a charging system, according to examples of the present disclosure.

FIG. 2 is a diagram illustrating a top view of a floating lift with a charging system, according to examples of the present disclosure.

FIG. 3 is a block diagram generally illustrating a bow stop with a smart charging station, according to examples of the present disclosure.

FIG. 4 is a diagram illustrating a smart bow stop and charging station, according to examples of the present disclosure.

FIG. 5 is a diagram illustrating a partial view of a floating lift with a charging system, according to examples of the present disclosure.

FIG. 6 is a block diagram illustrating a floating lift with a charging system including an integral charger, according to examples of the present disclosure.

FIG. 7 is a block diagram illustrating a floating lift with a charging system including an integral DC charger, according to examples of the present disclosure.

FIG. 8 is a diagram illustrating a lift charging system including a bow stop charging station, according to examples of the present disclosure.

FIG. 9 is a diagram illustrating a floating lift charging system, according to examples of the present disclosure.

FIG. 10 is a diagram illustrating a floating lift charging system, according to examples of the present disclosure.

FIG. 11 is a diagram illustrating a floating lift charging system, according to examples of the present disclosure.

FIG. 12 is a diagram illustrating a floating lift with a charging system, including example charging station locations on the floating lift.

FIG. 13 is a diagram illustrating a floating lift charging system including communication links with external devices.

FIG. 14 is a block diagram illustrating a floating lift with a charging system including a solar charger, according to examples of the present disclosure.

FIG. 15 is a diagram illustrating a floating lift with a charging system including solar panels, according to examples of the present disclosure.

FIG. 16 is a diagram illustrating a top view of a floating lift with a charging system including solar panels, according to examples of the present disclosure.

FIG. 17 is a diagram illustrating a floating lift charging system including a float charging interface unit, according to examples of the present disclosure.

FIG. 18 is a block diagram illustrating a floating lift charging system including a float charging interface unit, according to examples of the present disclosure.

FIG. 19 is a diagram illustrating a floating lift with a charging battery, according to examples of the present disclosure.

FIG. 20 is a diagram illustrating a top view of a floating lift with a charging battery, according to examples of the present disclosure.

FIG. 21 and FIG. 21A illustrate a partial view of a floating lift with a charging battery, according to examples of the present disclosure.

FIG. 22 is a system block diagram illustrating a floating lift with a primary power system, according to examples of the present disclosure.

FIG. 23 is a system block diagram illustrating a floating lift primary power system, according to examples of the present disclosure.

FIG. 24 is a system block diagram illustrating a floating lift with a DC Primary Power System, according to examples of the present disclosure.

FIG. 25 is a system block diagram illustrating a floating lift with a primary power system and including a solar charging system, according to examples of the present disclosure.

FIG. 26 is a diagram illustrating a floating lift with a primary power system and including a solar charging system, according to examples of the present disclosure.

FIG. 27 is a diagram illustrating a floating lift with a primary power system and including a solar charging system, according to examples of the present disclosure.

FIGS. 28A-D illustrate floating lift example battery pack locations, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

Watercraft Floating Lift with Charging System

The present disclosure provides a watercraft floating lift with a charging system. In one example, the floating lift is used as part of an electric watercraft charging system and includes an on-board charging system. The charging system can include a charging station entirely located on the floating lift, or can include components of the charging station located near the floating lift with a charging interface unit positioned on the floating lift.

Watercraft Floating Lift with Charging Battery

The present disclosure provides a Watercraft Floating lift with a charging battery. In one example, the floating lift is used as part of an electric watercraft charging system and includes an on-board charging system including a charging battery. The charging system can include a charging station entirely located on the floating lift, or can include components of the charging station located near the floating lift with a charging interface unit positioned on the floating lift. The charging battery is located on the floating lift to aid in charging a watercraft positioned on or near the lift and in need of a charge.

One or More Examples and Features of a Watercraft Floating Lift with a Charging System and/or Charging Battery are Detailed Herein and Illustrated in the Figures(s), and can Include a Combination of One or More of the Following Features.

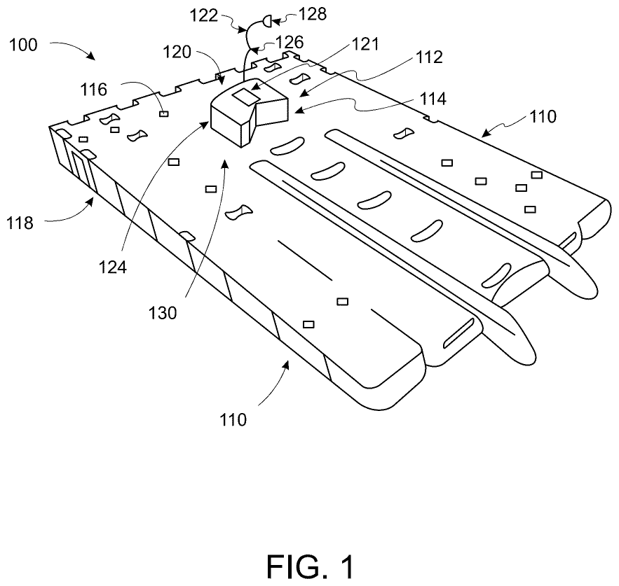

FIG. 1 is a diagram generally illustrating a floating lift 100 with a charging system, according to examples of the present disclosure. The floating lift 100 includes a float body 110 and a charging system 112. The charging system 112 includes one or more charging components 114 integrated into the float body. The float body 110 docks or stores a watercraft (e.g., an electric watercraft) when not in use. Charging system 112 is operable to charge an electric watercraft docked on the float body 110, and/or energize electric components located on the float body (lights, sensors, robotics, winches, etc).

The float body 110 includes a top side 116 and a bottom side 118. The charging system 112 includes a charging device 120 extending from the top side 116. The charging device 120 includes a charging mechanism 122 for charge coupling to an electric watercraft. The charging device 120 can be a charging station, or one or more charging components.

In examples, the floating lift 100 includes a bow stop 124 operably positioned on the top side 114. In one example, the charging device 120 is formed as part of the bow stop 124. In one example, the charging device 120 includes a charging port 121. The charging port 121 is coupled to a charging power supply via the bow stop 124 and float body 110. The charging mechanism 122 couples to the charging port 121. The charging mechanism 122 includes a charging cable 126 coupled to a charging plug 128. The charging plug 128 is located at an end of the charging cable 126. As such, the bow stop 122 is configured as a charging station 130 for charging an electric watercraft.

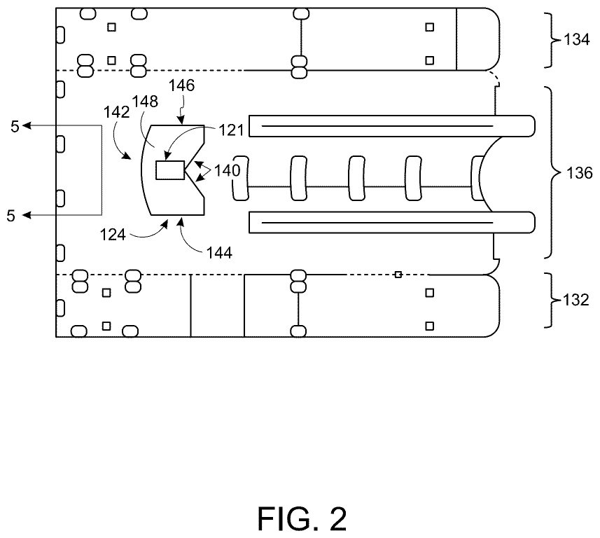

Reference is also made to FIG. 2. FIG. 2 is a diagram illustrating a top view of floating lift 100 with charging system 112, according to examples of the present disclosure. The float body includes a first edge region 132, a second edge region 134, and a bow support region 136. The bow support region 136 is located between the first edge region 132 and the second edge region 134. The bow stop 124 is located between the first edge region 132 and the second edge region 134, and spaced from an end of the bow support region 136.

The bow stop 124 includes multiple sidewalls, including a bow side 140, a front side 142, a first side 144, a second side 146, and a top side 148. The bow side 140 is configured to receive a bow of a watercraft. The front side 142 is opposite the bow side 140. The first side 144 is opposite the second side 146. In one example, the charging port 121 is located on the top side 148 (illustrated) or the front side 142 (not illustrated).

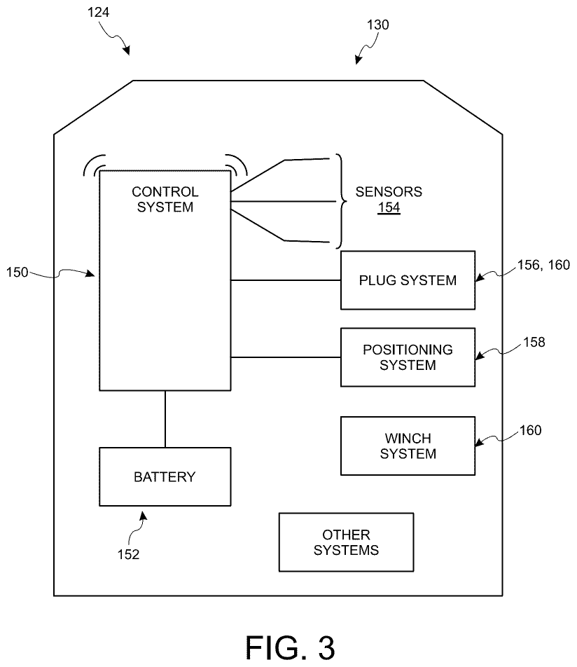

FIG. 3 is a block diagram generally illustrating a charging system including bow stop 124 with charging station 130, according to examples of the present disclosure. The charging station 130 is a smart charging station, and is located within bow stop 124. In one example, the charging station 130 includes a control system 150 with an on-board battery 152. Bow stop sensors 154 are coupled to control system 150. The bow stop sensors 154 can include a number of different sensors, including a bow sensor, an active charging sensor, a positioning sensor (e.g., positioning of the bow stop, positioning of the charging mechanism relative to a watercraft charging port, etc.), a charging marker sensor, a charging port sensor, etc. Plug system 156 and charging mechanism positioning system 158 are also in communication with control system 150. Additionally, control system 150 includes a communication system for communicating with other external devices. Such external devices include an external charging control system, a charging application (e.g., a user phone or computer system), or watercraft control system.

The bow stop 124 can include an electric motor operated winch system 160. The winch system 160 is controllable via control system 150. Other smart systems can be located on bow stop 124, that aid in operation of charging station 130. Plug system 162 is in communication with control system 150, for activation of the charging station charging device.

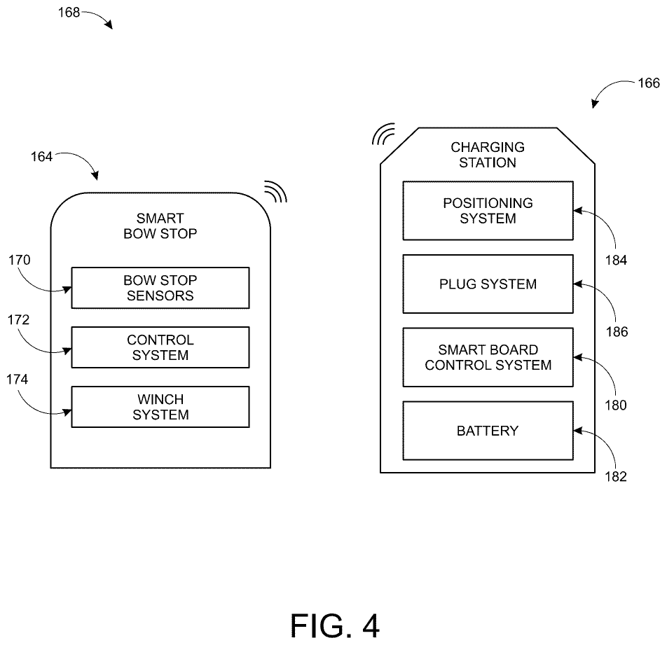

FIG. 4 is a diagram illustrating a charging system 168 including a smart bow stop and charging station, according to examples of the present disclosure. The bow stop 164 is located physically separate from the charging station 166. Components of charging system 168 can be located on both bow stop 164 and charging station 166.

In one example, bow stop 164 includes bow stop sensors 170, a bow stop control system 172, and an electric motor operated winch system 174. Charging station 166 includes a charging station control system 180, an on-board battery 182, a positioning system 184, and a plug system 186. Both the bow stop 164 and the charging station 166 can communicate with each other. Additionally, the bow stop 164 and the charging station 166 can communicate with a central control system, watercraft control system, other control system or application.

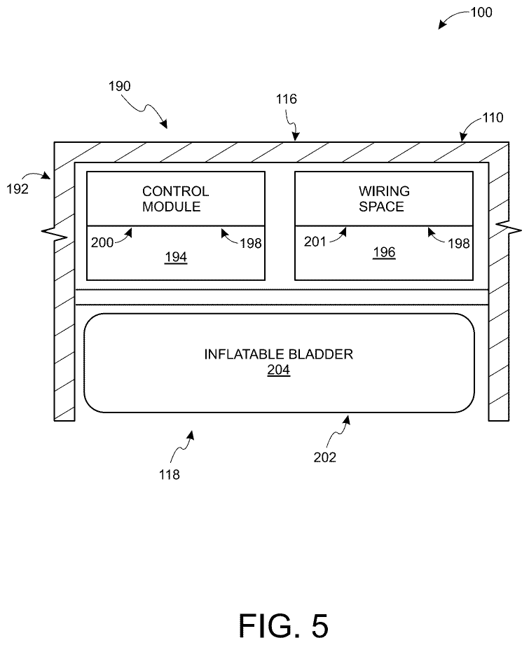

FIG. 5 is a diagram illustrating a partial view of a floating lift with a charging system 190, according to examples of the present disclosure. In one example, components of the charging system 190 are located within the floating lift 100 float body 110. In another example, an entire charging station 192 is located within the float body 110.

In one example, the float body 110 includes one or more cavities suitable for containing the charging system components, charging power cables, and control wiring. In one example illustrated, the float body 110 includes a first cavity 194 and a second cavity 196 adjacent the top side 116. One or more charging system components 198 are positioned within the first cavity 194 and the second cavity 196. In one example illustrated, the charging station control system 200 is located in first cavity 194. The charging station charging power cables and control wiring 201 are routed through second cavity 196.

In one example, the float body 110 includes a bottom cavity 202. The bottom cavity 202 can be open to the bottom side 118. The bottom cavity 202 can be used to hold an inflatable bladder 204 for controlling flotation of the floatable lift 100.

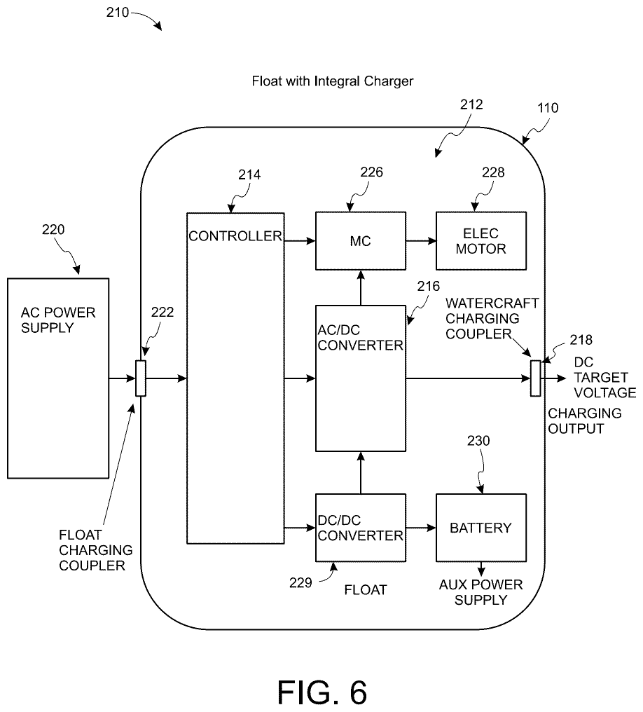

FIG. 6 is a block diagram illustrating a floating lift 210 with a charging system 212 including an integral charger, according to examples of the present disclosure. The charging system 212 is primarily located within float body 110. The charging system 212 provides charging power to a watercraft docked on the floating lift 210, charging power to a watercraft docked nearby float 210, and provides power to systems located on the floating lift 210.

In one example, the floating lift 210 charging system 212 includes a controller 214, an AC/DC converter 216, and a watercraft charging coupler 218. In operation, AC charging power is supplied to the float lift 210 via AC power supply 220. Charging power is input to the floating lift 210 at float charging coupler 222, that is coupled to controller 214. Controller 214 controls the feed of charging power through the floating lift 210 to AC/DC converter 216. The AC/DC converter converts the input AC voltage to a DC target voltage used by the watercraft needing a charge. The DC target voltage is output to a watercraft requesting a charge via watercraft charging coupler 218.

An on-board motor controller 226 and electric motor 228 are coupled to controller 214. The motor controller can include a DC/DC converter to supply a DC voltage to electric motor 228. Alternatively, motor controller 226 can receive a DC voltage power supply from AC/DC converter 216 and can include a DC/DC converter to convert the DC supply voltage to the electric motor target/operating voltage (e.g., 408 volt DC, 240 volt DC). The electric motor can be utilized to operate one or more devices located on the floating lift 210, including a winch system or a plug positioning system.

A DC/DC converter 229 is provided to convert the DC input voltage to a DC target voltage for charging on-board battery 230. Battery 230 supplies power to auxiliary floating lift devices, including lift sensors, lift lighting, and other lift systems.

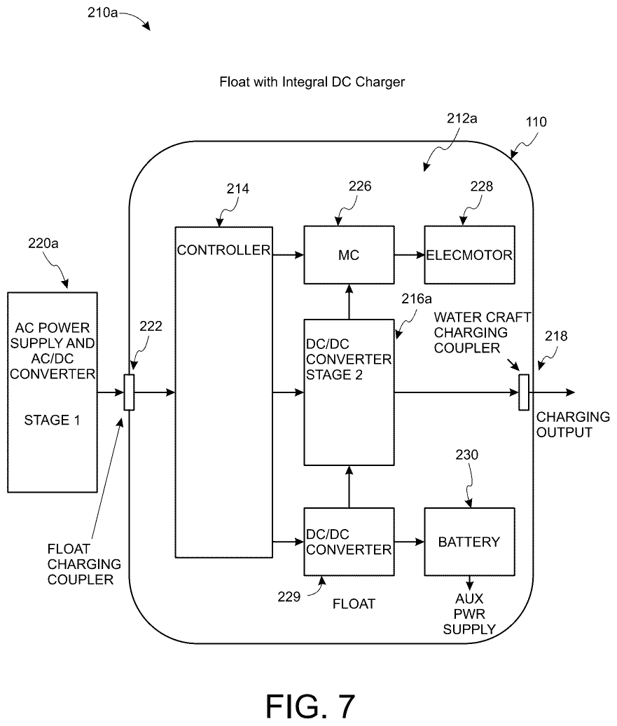

FIG. 7 is a block diagram illustrating a floating lift 210a with a charging system 212a including an integral DC charger, according to examples of the present disclosure. The floating lift 210a is similar to floating lift 210, and the other floating lifts previously detailed herein. The floating lift 210a includes charging system 212a that is part of a 2 stage DC charging system. Stage 1 is located separated from the floating lift 210a and converts an AC supply voltage to a stage 1 DC voltage, which is a higher voltage than the electric watercraft target voltage.

In one example, AC power supply 220a is provided external to the floating lift 210a. The AC power supply includes an AC/DC converter for converting the AC supply voltage to the desired stage 1 DC voltage. In one example, the stage 1 DC voltage is greater than 600 volts DC. The AC power supply 220a can be configured to provide a stage 1 DC supply voltage to multiple floating lifts with electric vehicle chargers.

At floating lift 210a, the charging system 212a includes stage 2 DC/DC converter 216a for converting the stage 1 DC voltage level to a stage 2 DC voltage level that is the target voltage of the electric watercraft needing a charge. In one example, the stage 2 DC voltage is 600 volts DC or less. The stage 2 DC/DC converter 216a provides a DC charging voltage to an electric water craft via watercraft charging coupler 218.

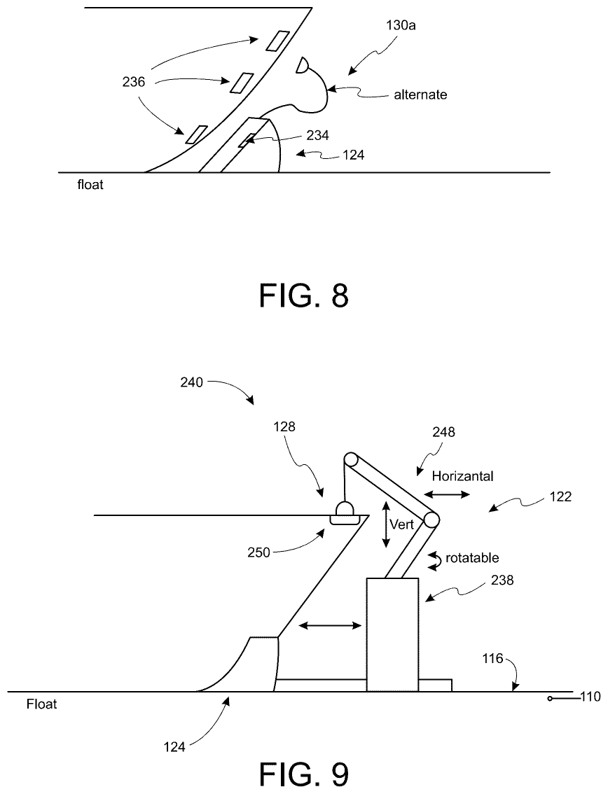

FIG. 8 is a diagram illustrating a floating lift charging system including a bow stop charging station, according to examples of the present disclosure. The bow stop charging station 130a is similar to the bow stop charging stations previously detailed herein. The bow stop charging station 130a is a contact charging station, and includes contact mechanisms 234 for making a charging connection to the watercraft needing a charge. In one example, the bow of the watercraft includes charging contact locations 236. Once the bow of the watercraft is positioned against the bow stop 124, the bow charging contact locations 236 are in alignment and electrical contact with the charging station contact mechanisms 234. Alternatively, a charging cable extending from the bow stop 124 can be configured to contact couple to the watercraft at the bow contact locations 236. In one example, the charging cable plug is an electromagnetic plug for contact coupling to a watercraft charging contact location or charging port.

FIG. 9 is a diagram illustrating a floating lift charging system 240, according to examples of the present disclosure. In one example, the charging station 238 is located separate from the bow stop 124. The charging station 238 extends from a top side 116 of the float body 110, and is adjustable relative to the bow stop 124. In one example illustrated, the charging station 238 charging mechanism 122 is a robotic arm 248. The robotic arm 248 can be an articulating arm mechanism that is attached to the charging cable. The robotic arm 248 positions the charging plug at the watercraft charging port. In one or more examples, the robotic arm 248 is movable in multiple directions. For example, the robotic arm 248 is movable in a vertical direction, a horizontal direction, and rotatable, all relative to a plane defined by the float body 110 top surface. The robotic arm can manually or automatically position and electrically couple the charging plug 128 to a watercraft charging port 250.

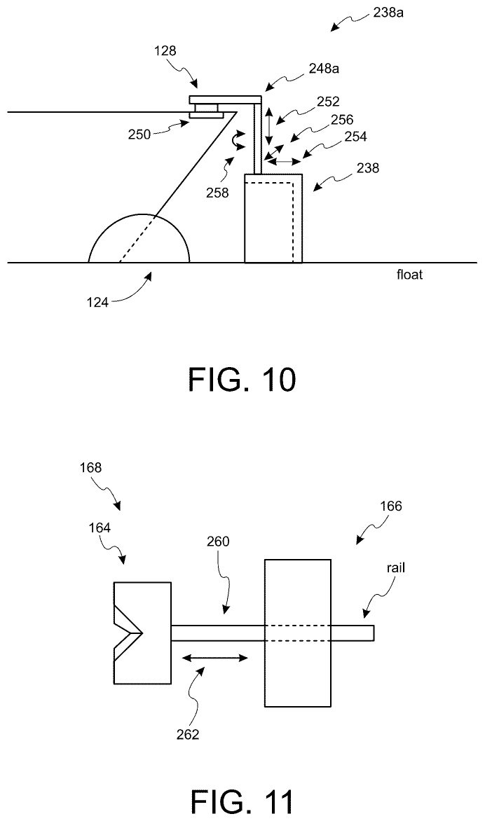

FIG. 10 is a diagram illustrating a floating lift charging system 238a, according to examples of the present disclosure. The charging station 238a is similar to the charging station 238 of FIG. 9, and includes a robotic arm 248a for positioning and aligning a charging plug 128 with an electric watercraft charging port 250. The robotic arm can be movable automatically or manually. The robotic arm 248a is a mechanical arm that is capable of rotating in a first vertical direction 252, a second horizontal direction 254, a third horizontal direction 256, and/or a fourth rotational direction 258.

FIG. 11 is a diagram illustrating a top view of floating lift charging system 168, according to examples of the present disclosure. Floating lift charging system 168 includes bow stop 164 which is separate from charging station 166. The bow stop 164 and charging station 166 can be similar to other bow stops and charging stations detailed herein. The bow stop 164 is movable relative to the charging station 166. In one example, the charging system 168 includes a rail system 160. The bow stop 164 and/or the charging station 166 are positioned along the rail system 160, and movable along the rail system 160. This allows positioning of the charging station 166 relative to a watercraft located at on the floating lift at bow stop 164, to aid in positioning the charging system 166 in a desirable position for charging the electric watercraft.

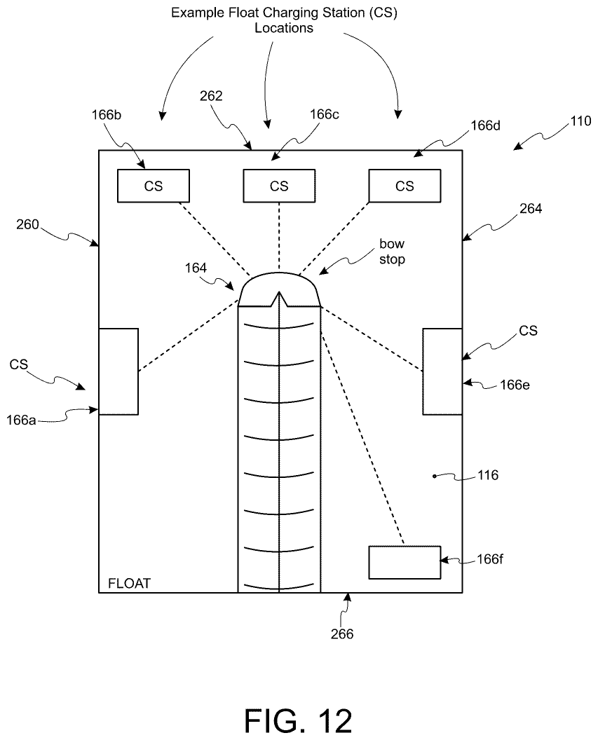

FIG. 12 is a diagram illustrating a floating lift with a charging system, including example charging station locations on the floating lift. In one example, the charging station 166(a,b,c,d,e,f) is located separate from the bow stop 164. The charging station 166 can be located at a number of locations about the float body 110. For example, the float body 110 includes a first side, a second side, and a third side. The charging station 166 can be located along the first side 260 (charging station 166a), the second side 262 (charging station 166b, 166c, 166d), third side 264 (charging station 166e), or fourth side 266 (charging station 166f). The respective charging stations 166 can be electrically coupled to bow stop 164 through the float body 110 internal cavities as previously detailed herein. An electric watercraft can be charged directly from the charging station 166 or through the bow stop 164.

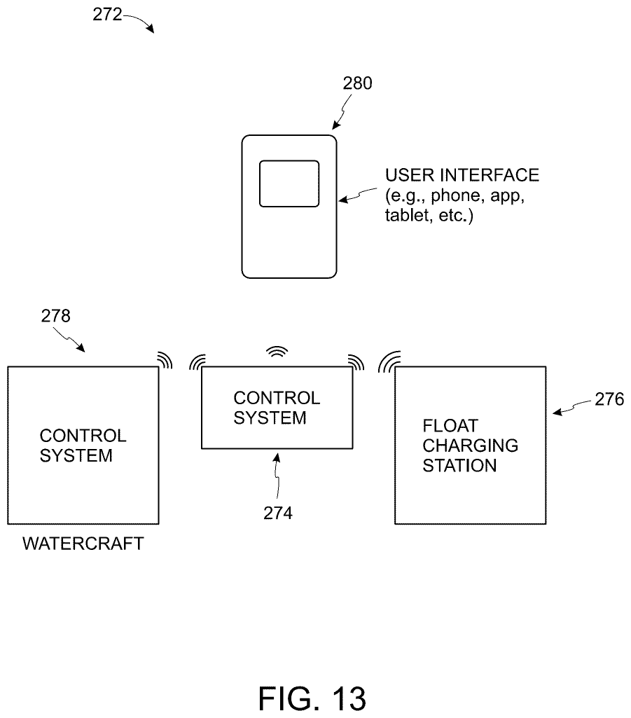

FIG. 13 is a diagram illustrating a floating lift charging system including a charging communication system 272 for communication between the floating lift charging system and external devices. In one example, a central control system 274 is provided. A float charging system 276, watercraft control system 278, and/or external user interface or application devices 280 all communication with each other (either directly or through the central control system 274. The user interface devices 280 can include one or more of a phone, a phone application, a table, a computer, or other smart device).

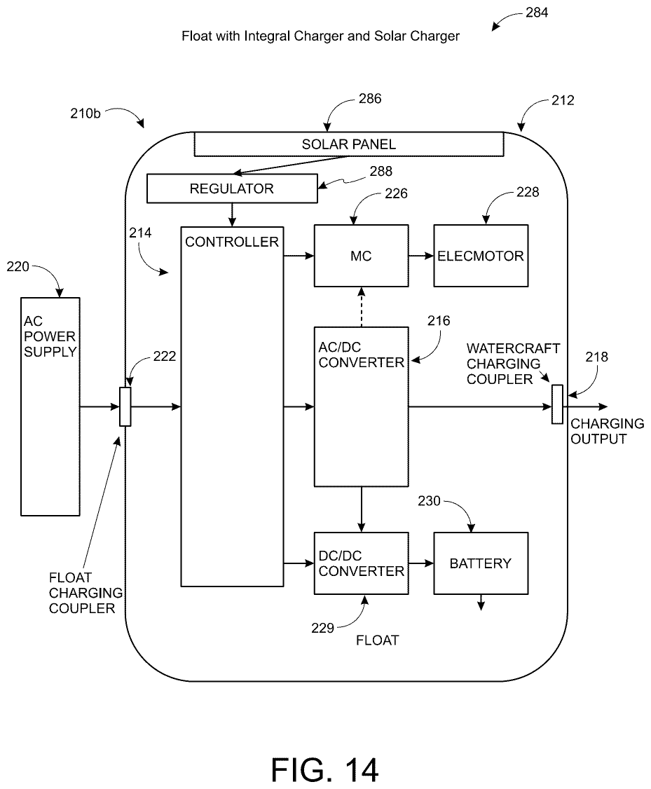

FIG. 14 is a block diagram illustrating a floating lift 210b with a charging system 212b including a solar charger, according to examples of the present disclosure. The charging system 210b is similar to the charging systems detailed herein, and further includes a solar charger 284. In one example, the solar charger 284 includes a solar panel 286 and voltage regulator 288. The solar panel 286 is located on the top side 116 of float body 110. The voltage regulator is located at the solar panel 286 or located near the charging system 210b charging station. The solar charger 284 is coupled to the charging system 210 controller, and can be used to aid in direct charging an electric watercraft. The solar charger 284 can also be used to charge the charging system auxiliary battery 230 and/or power other devices located on the floating lift 100.

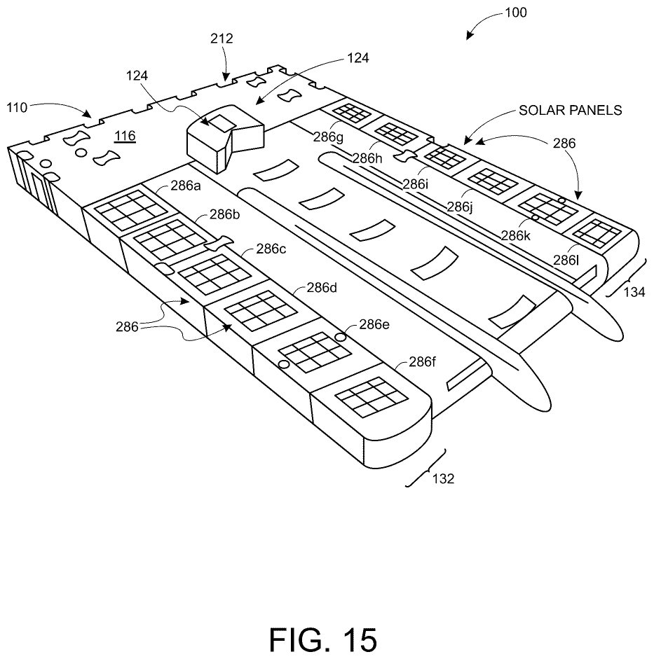

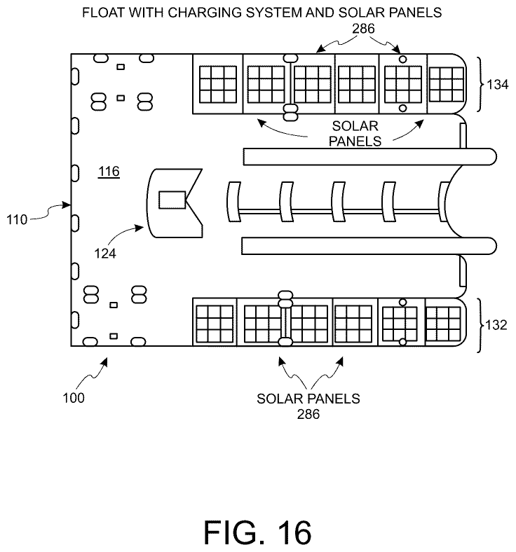

FIG. 15 is a diagram illustrating a floating lift with a charging system including solar panels, according to examples of the present disclosure. FIG. 16 is a diagram illustrating a top view of a floating lift with a charging system including solar panels, according to examples of the present disclosure. In reference to FIG. 15 and FIG. 16, the solar panels 286 can be positioned at any suitable location along the top 116 or the float body 110. In one example, the solar charger solar panels are located along first edge region 132 and second edge region 134. Each of the solar panels 286a,b,c,d,e,f,g,h,i,j,k,l are coupled to the top surface of top side 116, and electrically coupled to the charging station 212 via electrical wiring routed through the float body 110. In one or more examples, the electrical wiring is routed through the float body 110 through cavities in the float body 110 as previously detailed herein.

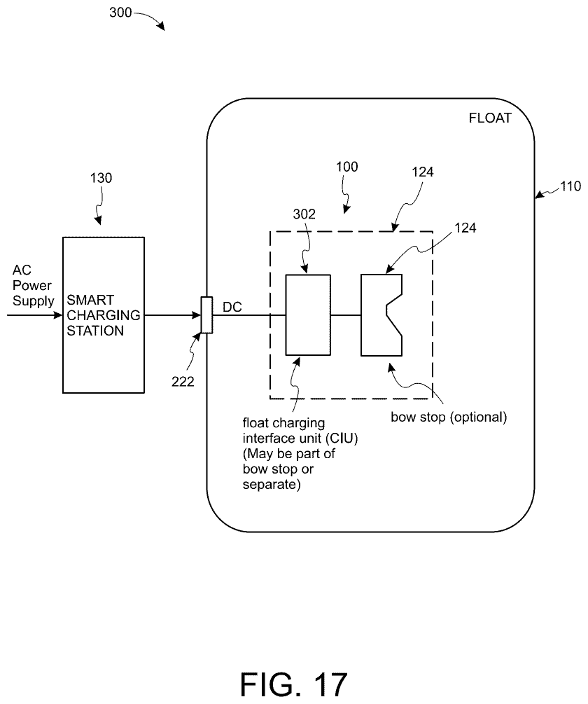

FIG. 17 is a diagram illustrating a floating lift including a charging system 300 including a float charging interface unit 302, according to examples of the present disclosure. The charging system 300 is similar to charging systems previously detailed herein. The charging system 300 includes a charging station 130 and further includes the charging interface unit 302. The charging station 130 is located off of the floating lift 100. The charging interface unit 302 is located on the float body 110. The charging interface unit 302 includes one or more components of the charging system, and in one example, includes only the charging system components that need to be located on the floating lift 100 float body 110. The charging interface unit 302 may be located integral the bow stop 124 or separate from the bow stop 124. Alternatively, the floating lift may not include a bow stop.

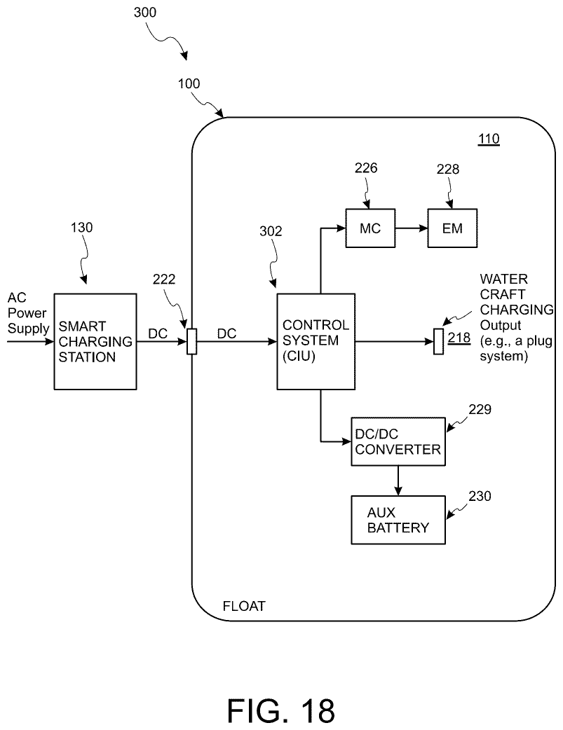

FIG. 18 is a block diagram illustrating a floating lift having the charging system 300 including the float charging interface unit 302, according to examples of the present disclosure. The charging interface unit 302 operates as a power and control interface between the charging station 130 and the float body 110 on-board devices, since the charging station is located remote from or off of the float body 110. In one or more examples, the charging interface unit 302 operates as a charging interface between the charging station 300 and the float watercraft charging output 218. Additionally, the charging interface unit 302 operates as an interface between the charging station 300 and the on-board motor controller 226/electric motor 228 and the DC/DC converter 229/auxiliary battery 230.

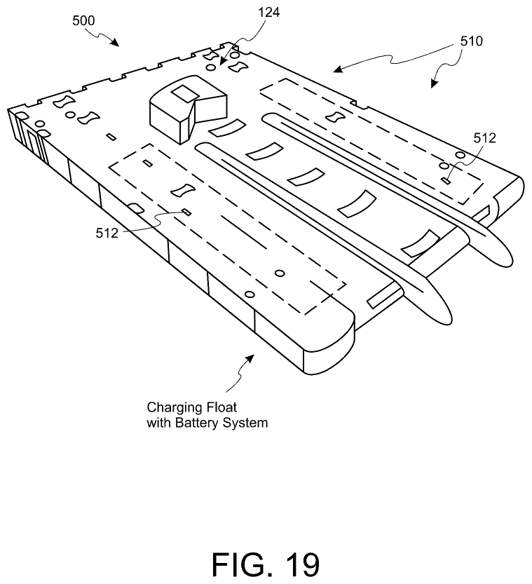

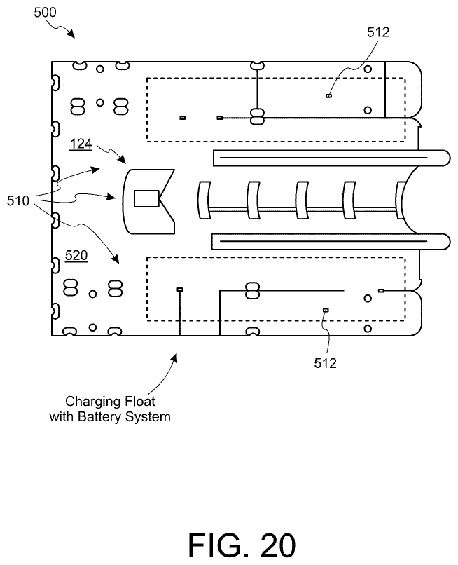

FIG. 19 is a diagram illustrating a floating lift 500 with a charging battery, according to examples of the present disclosure. FIG. 20 is a diagram illustrating a top view of a floating lift with a charging battery, according to examples of the present disclosure. Reference is made to FIG. 19 and FIG. 20. In one example, the floating lift 500 is used as part of an electric watercraft charging system and includes an on-board charging system 510 (or components thereof) and a charging battery 512 (e.g., a battery, multiple batteries, or a battery pack). The charging system 510 can include a charging station entirely located on the floating lift 500, or can include components of the charging station located near the floating lift 500 with a charging interface unit 514 positioned on the floating lift 500. The charging battery 512 is located on the floating lift 500 to aid in charging a watercraft positioned on or near the lift and in need of a charge.

In one example, the floating lift 500 includes a lift body 520. The charging battery 512 is in the form of a battery pack located within the lift body 520 and/or coupled to a top surface of the lift body 520. The charging system 510 similar to one or more charging systems previously detailed herein. The charging battery 512 is charged by the charging system and can operate with the charging system to aid in charging an electric watercraft located on or near the floating lift 500.

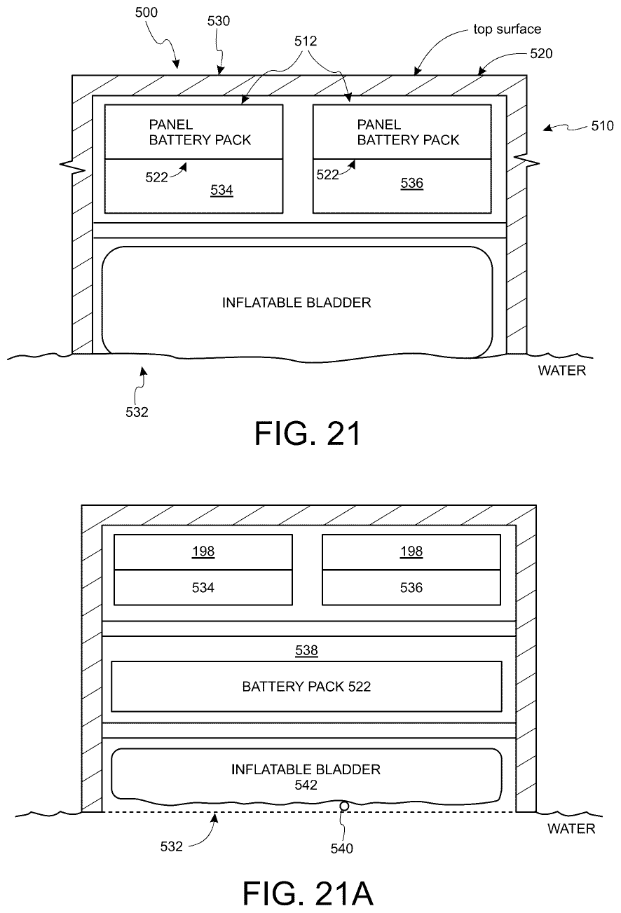

FIG. 21 is a diagram illustrating a partial view of floating lift 500 with a charging battery, according to examples of the present disclosure. The charging battery 512 is a battery pack 522 located in the lift body 520. In one example, the floating lift body 520 includes one or more cavities that contain the battery pack or parts of the battery pack 522. The lift body 520 can also contain other components of the floating lift charging system 510.

In examples, the lift body 520 includes a top 530 and a bottom 532. In operation, bottom 532 faces the water. The lift body includes a first cavity 534 and a second cavity 536. The first cavity 534 and the second cavity 536 are located near the top 530. The battery pack 522 is made up of multiple panel batteries located in the first cavity 534 and the second cavity 536. Alternatively, as illustrated in FIG. 21A, the battery pack 522 can be located in an intermediate cavity. The intermediate cavity 538 is positioned between the first and second cavities 534,536 and the bottom 532. In one example, the float body 520 includes a bottom cavity 540, where the intermediate cavity 538 is located between the first and second cavities 534,536 and the bottom cavity 540. The bottom cavity 540 can include an inflatable bladder 542 to aid in floating the floating lift 500. The bottom cavity 540 can be open to the bottom 532.

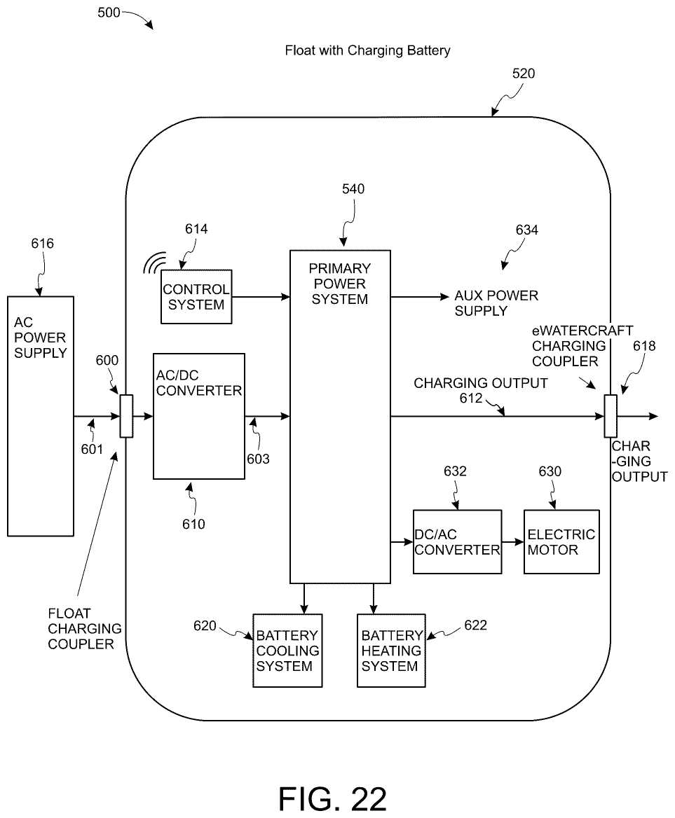

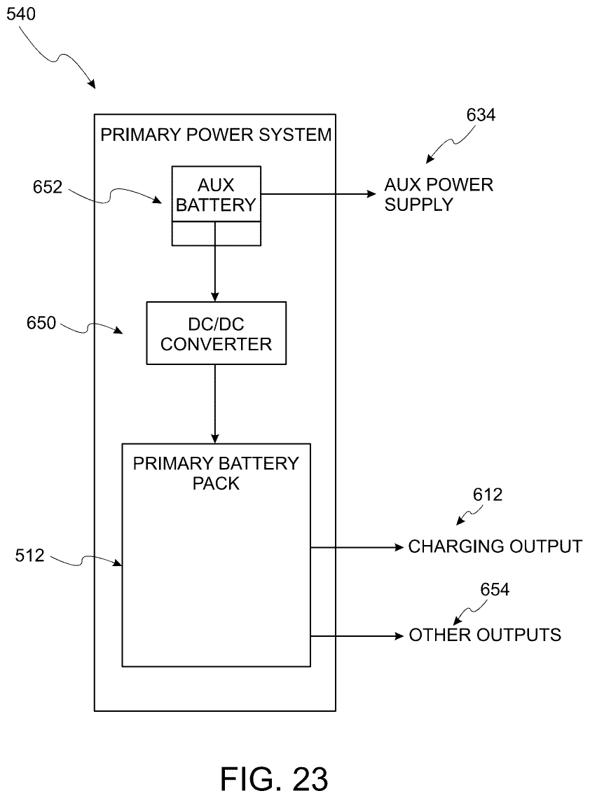

FIG. 22 is a system block diagram illustrating a floating lift 500 with a primary power system 540, according to examples of the present disclosure. The primary power system 540 includes the charging battery 512. The primary power system is located within the float body 520, or includes components located on the float body 520 or within the float body 520.

The floating lift 500 includes a float charging coupler 600, an AC/DC converter 610, primary power system 540, and a charging output 612. A watercraft charging coupler is connected to the charging output 612. A control system 614 is coupled to the primary power system 540. In operation, AC power supply 616 provides AC charging power input to the floating lift 500 charging system. The AC charging power is input to the floating lift 500 at the float charge couple 600. AC power 601 is input to the AC/DC converter via the float charge coupler 600. The AC/DC converter 610 converts the AC input voltage 601 to a DC charging voltage 603 (e.g., 600 volts DC). The DC charging voltage 603 is input to the primary power system 540. The primary power system 540 uses the input DC power 603 to direct charge a watercraft via the charging output 612 and/or charge the battery pack 512 contained in the primary power system 540. A watercraft can charge couple to the floating lift 500 charging system via the charging coupler 618.

Control system 614 coordinates with a user interface to control charging of a watercraft or charging of the primary power system 540 battery banks. Additionally, the floating lift 500 can include a battery cooling system 620 and/or a battery heating system 622. The control system 614 or other controller (e.g., a primary power system on board controller) can control battery temperature via the battery cooling system 620 or the battery heating system 622.

Additionally, the primary power system 540 can power other external devices. In one example, the primary power system 540 powers an electric motor 630. The primary power system 540 is coupled to the electric motor 630 through a DC/AC converter 632. The primary power system 540 provides an auxiliary power supply 634 that can be used to energize other devices on the floating lift 500 (e.g., lights, sensors, motors, etc.)

FIG. 23 is a system block diagram illustrating the floating lift primary power system 540, according to examples of the present disclosure. The primary power system 540 is contained on the floating lift, and includes primary battery pack 512. Additionally, the primary power system can include a DC/DC converter 650 and an auxiliary battery 652. The primary battery pack 512 provides charging output 612 and other outputs 654. The primary battery pack is lithium based battery pack, solid state battery pack or other suitable battery technology.

The DC/DC converter receives a DC voltage from the primary battery pack and converts it to a lower DC voltage for charging auxiliary battery 652. In one example, the primary battery pack DC voltage is 600 volts or greater. The auxiliary battery 652 is 208 volts or lower. The auxiliary battery provides auxiliary power supply output 634 at a lower DC voltage to power on-float lower voltage devices.

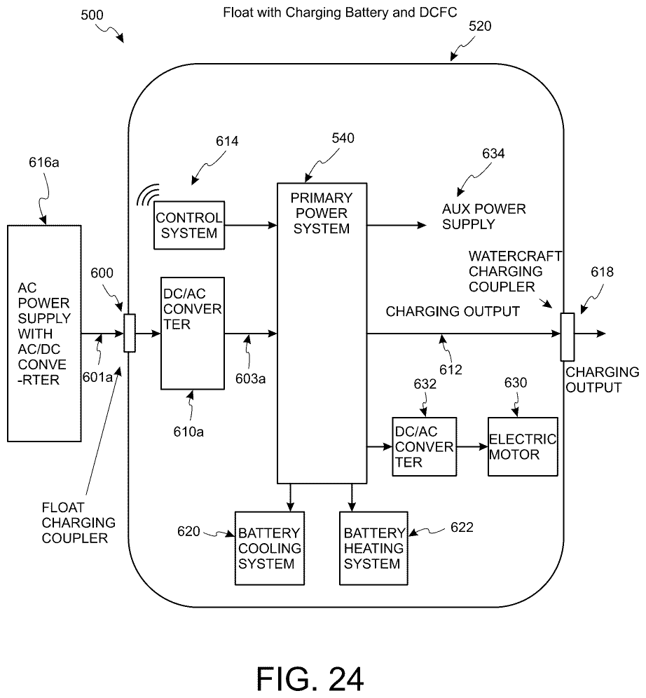

FIG. 24 is a system block diagram illustrating a floating lift 500a with a DC power system 660, according to examples of the present disclosure. The floating lift 500a is similar to floating lifts previously detailed herein, including floating lift 500. In one example illustrated, the DC power system 660 is a two stage DC power system. AC power supply 616a includes an AC/DC converter for converting an input AC voltage power to a first stage DC supply voltage. In one example, the first stage DC supply voltage is greater than 800 volts DC. First stage DC supply voltage 601a is input to the floating lift 500a at float charging coupler 600. Within the floating lift 500a, the first stage DC supply voltage is input to DC/DC converter 610a. DC/DC converter provides a second stage DC voltage 603a to the primary power system 540. In one example, the second stage DC voltage is 600 volts or less.

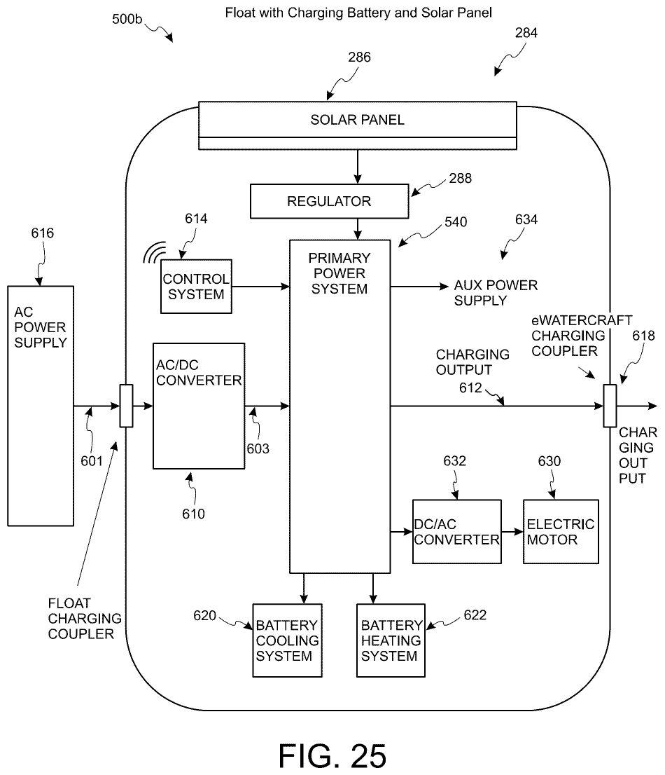

FIG. 25 is a system block diagram illustrating a floating lift 500c with a primary power system and including solar charging system 284, according to examples of the present disclosure. The solar charging system 284 is similar to the solar charging system previously detailed herein, and includes solar panel 286a and regulator 286b. The solar charging system 284 provides charging power to primary power system 540. The solar charging system 284 is utilized by primary power system in multiple ways. The solar charging system 284 can be used to charge primary battery pack 512 or aid in charging primary battery pack 512. Solar charging system 284 can also be used to charge auxiliary battery 652. In one example, auxiliary battery 652 is only charged via solar charging system 284. In other examples, solar charging system 284 is used to charge other battery systems located on floating lift 500c.

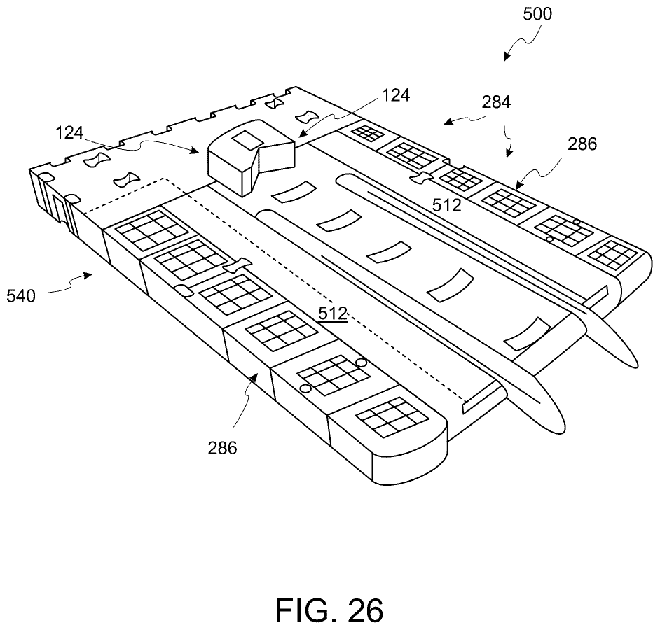

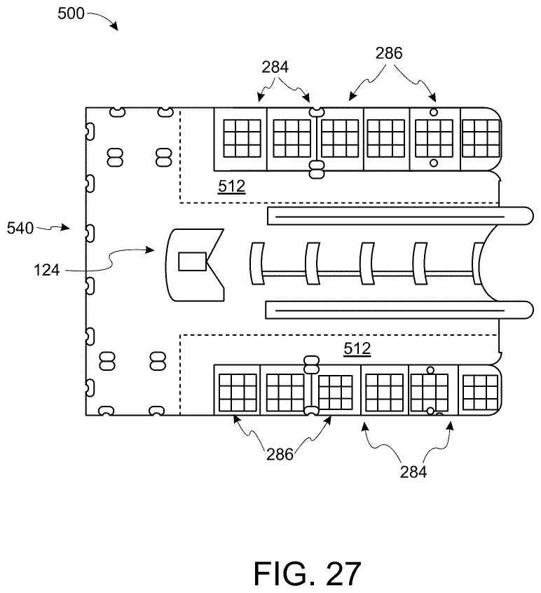

FIG. 26 is a diagram illustrating a floating lift with a primary power system and including a solar charging system, according to examples of the present disclosure. FIG. 27 is a diagram illustrating a floating lift with a primary power system and including a solar charging system, according to examples of the present disclosure. FIG. 26 and FIG. 27 illustrate one example of a floating lift 500 with primary power system 540 including a battery pack 512, and a solar charging system 284 including solar panels 286 coupled to a top surface of the floating lift 500.

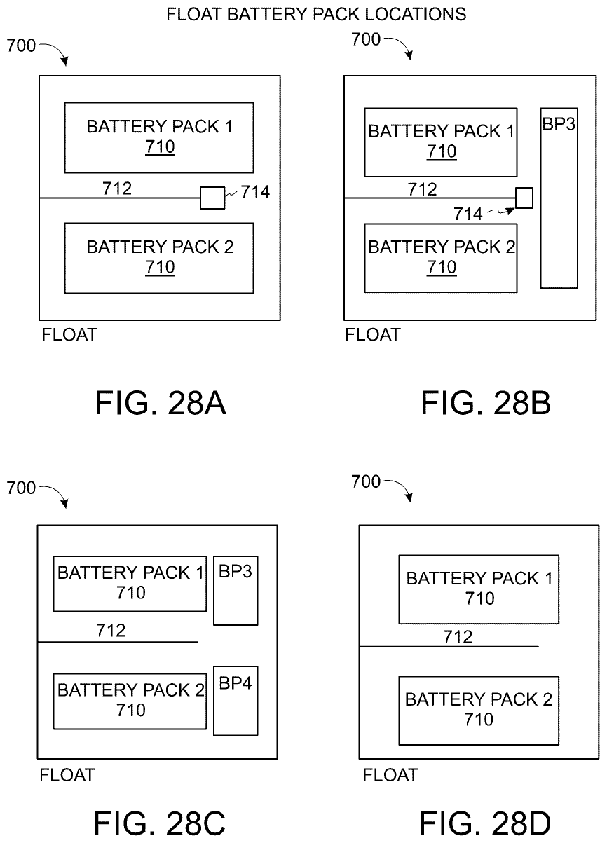

FIGS. 28A-28D are diagrams illustrating a floating lift 700 example battery pack 710 locations, according to examples of the present disclosure. In FIG. 28A, two main battery packs 710 are located within the float body on each side of the bow support area 712 and bow stop 714. In FIG. 28B, a third battery pack is located on the other side of the bow stop 714. In FIG. 28C, two main battery packs are located on each side of the bow support area 712. A third battery pack BP3 and a fourth battery pack BP4 are located on the end of each corresponding main battery pack. In FIG. 28D, two main battery packs 710 are located within the float body on each side of the bow support area 712. Battery packs can be located in other areas of the float body not illustrated, including within the bow support area 712.

One or More Examples and Features of a Watercraft Floating Lift with a Charging System and/or Battery System are Detailed Herein and and can Include a Combination of One or More of the Following Features.

### Energized Floating Lift

Floating lift. Floating lift can be configured to aid in charging a watercraft.
Floating lift material. Floating lift is generally made of a molded material (e.g., plastic).
Integral Charging System. Charging system is integrated into the floating lift.
Manual or Automatic connection. Floating lift charging station can be manually connected to a watercraft, or automatically connected to a watercraft for performing a charging operation.
Automatic Connection. Automatic connection could be on or more combinations of robotic, magnetic, or wireless.
AC or DC Charging Power. Can include a primary AC or DC power supply, and may also include a secondary power supply (e.g., a solar panel).
Electromagnetic Coupling. Floating lift charging system can automatically couple electromagnetically to a watercraft.
·Integral Charger. Floating lift includes an integral charging system.

### Float Charging System

AC Powered. In one example, floating lift is fed from an AC power source for level 1, 2, or 3 charging.
Float Charge Coupler. Floating lift includes a mechanism for coupling between the AC power supply and the floating lift. In one or more examples, the float charge coupler is a (e.g., standard) charging plug, or other coupling system such as a magnetic or electromagnetic plug.
On-Board Controller. AC Power can be fed through an on-board controller.
AC/DC Converter. AC Power is fed to an AC/DC Converter for converting the AC input voltage to a DC target charging voltage which is output to the watercraft needing a charge.
Watercraft Charging Coupler. The float charger is coupled to the watercraft via a plug charger that can be a physical plug charger, or utilize another charging plug system such as a magnetic or electromagnetic connection system.
Electric Motor. The controller can also feed a motor controller coupled to an electric motor. One or more electric motors can be used to aid in moving the watercraft on and off the boat lift, and can be used for other systems such as a handsfree connection system and/or plug positioning system for coupling the float charger to a watercraft to perform a charging operation.
DC/DC Converter plus Aux Battery. The float can include an onboard DC/DC converter coupled to an auxiliary battery for powering one or more on-board components.
DC Charging System. In one example, the float charger can be configured as a DC charging system. In one example the DC charging system is a DC fast charging system. In another example, the DC charging system is a two stage DC charging system.
   Float with Solar Charger
Solar Charger. The float charger can include a solar charger (e.g., a built-in solar charger). The solar charger can be used to charge (i.e., trickle charge) the watercraft while docked and not in use. The solar charger can be used to simultaneously charge the watercraft at the same time as the AC or DC charger. The solar charger can be used to charge an auxiliary battery.
Solar Panels. Solar panels can be located on the float in many different configurations. In one example, solar panels are located along the outer side edges to allow for a walkway while going on or off the watercraft.

### Bow Stop and Charging Station

Bow Stop with Charging Station. In one example, the bow stop and charging station are located in one single unit. The single unit can include a molded housing.
Bow Stop with Charging Plug. A charging plug can be configured to be extendable from the bow stop.
Bow Stop with a separate Charging Station. The charging station can be located separate from the Bow stop. For example, the charging station can be located on an end or side of the watercraft float/docking area.
Bow Stop. The bow can be shaped similar to a conventional bow stop, and include additional features. For example, the bow stop can include a charging station including a charging plug system, a charging station positioning system, metering, auxiliary battery, watercraft contacts, sensors and lights. The bow system can be configured to be used with an electromagnetic plug system, and handsfree automatic positioning and plug connection system. The charging system can be configured to communicate wired or wirelessly with the on-board watercraft smart system and a charging app (e.g., via a phone app, tablet or computer).
Adjustable Bow Stop. The bow stop can be adjustable on the float. For example, the bow stop can include a charging station. The bow stop can be adjustable on the float surface. The bow stop can be separated from the charging station, and is adjustable relative to the charging station. In one example, the charging station is located on a rail couple to the float surface and extending from the bow stop. The charging station can be moved along the rail and separated from the bow stop based on the size and contour of the watercraft that is parked on the float.
Robotic System. The robotic system can be a robotic arm system (e.g., an articulating arm). In one or more examples, the robotic arm system can be an articulated arm, a six-axis arm, a collaborative robot arm, a SCARA arm, a Cartesian arm, a cylindrical arm, a spherical/polar arm, a parallel/delta arm, a anthropomorphic arm, and/or a dual-arm system. In other examples, an articulating arm may be manually adjustable (i.e., non-robotic).
Positioning System. A positioning and alignment system can be used to align the charging plug with the watercraft charging port. Example positioning systems can include optical sensors, infrared sensors/reflectors or other alignment systems and methods.

### On-Board Charging System

Charging System. The charging system can be totally located on the float or partially located on the float. The charging system can be located above the deck of the float or at least partially be located below the deck of the float.
Charging System Target Voltage. The charging system can include a voltage selector switch (either a physical switch or via a graphical user interface) for adjusting the float voltage output to match the target voltage of the watercraft requesting a charging operation.

### Charging Interface Unit

Charging Interface Unit. In one example, a charging interface unit is located on the float. The charging interface unit can be part of the bow stop, or located separate from the bow stop.
Smart CIU. The charging interface unit can act as a location near a watercraft located on the float for accessing a charging plug. The CIU can also include a robot system (e.g., an articulated arm) to aid in positioning a charging plug on a watercraft charging port. Can include a smart system for communicating with at least one of the float system control systems, the charging station, and/or the watercraft requesting/needing a charge.
Charging Interface. The CIU operates as a charging interface between the float charging station and the watercraft requesting a charge. In one example, the charging interface unit is located adjacent (and not on) the floating dock. Only the CIU is located on the floating dock.

### On Board Auxiliary Battery

Auxiliary Battery. The float system can include an auxiliary battery (or more) for powering one or more float components, and for emergency powering of one or more components on the watercraft.
Float Support System. The float may include a float support system. In one example, the support system includes an inflatable bladder-(or other suitable compressed air container) for aiding in supporting and floating the float charger.
Charging System Location. The charging system may be partially or entirely located below or above the float deck.

### On Board Charging Battery

On Board Charging Battery. The float charger can include an on-board battery charger for charging the watercraft. The float charger can be configured to charge an on-board battery rack for charging the watercraft, or the float charger can direct-charge the watercraft. A solar charging system can be located on the float charger for charging the on-board battery rack, direct-charging the watercraft, or charging the auxiliary power system and auxiliary battery.
On-Board Charging Battery System. The on-board charging battery system can be made up of one or more battery racks. In one example, the battery racks are made up of lithium ion batteries configured as stacked panel batteries.
Auxiliary Battery. The float system can include an auxiliary battery (or more) for powering one or more float components, and for emergency powering of one or more components on the watercraft.
Float Support System. The float may include a float support system. In one example, the support system includes an inflatable bladder (or other suitable compressed air container) for aiding in supporting and floating the float charger.
Battery Cooling/Heating System. An on-board battery cooling and/or heating system may be provided to optimize battery temperature during charging of the on-board charging battery.
Charging System Location. The charging system may be partially or entirely located below or above the float deck.

### Other Charging Float Systems

Winch system. A winch with an AC motor or DC motor (e.g., a DC stepper motor). Can be energized via the charging system or the charging battery.
Step System. A step system to aid in getting on or off a watercraft. The step system can be a step up or step down configuration that extends from the float surface, or may extend upward from the float surface and act as a bridge, and is positioned between the side of the watercraft and a dock. The height of the step system can be adjustable.
Motorized Step System. In one example, the step system is motorized and can be moved up and down using a small motor (e.g., controlled via an application or remote control). The motor can be a DC motor or an AC motor, and can be energized through the charging station. Could also be energized using incoming float power, auxiliary power, or power from the charging battery.
   It is Recognized that the Charging System of the Present Disclosure can be Configured for Use in Many Charging System Applications, Including Those not Disclosed Herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. A watercraft floating lift comprising:
a float body; and
a charging system, including one or more charging system components integrated into the float body.

2. The floating lift of claim 1, comprising:
the float body including a top side and a bottom side; and
a charging device extending from the top side, the charging device including a charging mechanism for charge coupling to an electric watercraft.

3. The floating lift of claim 1, comprising:
a bow stop operably positioned on the top side.

4. The floating lift of claim 3, where the charging device is formed as part of the bow stop.

5. The floating lift of claim 2, where the charging mechanism includes a charging cable coupled to a charging plug.

6. The floating lift of claim 1, comprising:
the float body including a top side, a bottom side, a first top cavity, the top cavity having the one or more charging system components positioned therein, and a bottom cavity.

7. The floating lift of claim 6, comprising an inflatable bladder positioned in the bottom cavity.

8. The floating lift of claim 6, comprising a second top cavity, the second top cavity including charging system wiring positioned therein, where the charging system wiring is routed from a location external to the float body to the charging device and passing through the second top cavity.

9. A floating lift comprising:
a float body;
a bow stop located on the float body, the bow stop including a charging station.

10. The floating lift of claim 9, comprising:
the float body including a top surface having a bow support region, where the bow stop is located near an end of the bow support region.

11. The floating lift of claim 9, comprising:
the float body including a first edge region, a second edge region, and a bow support region; and
where the bow support region and the bow stop are located between the first edge region and the second edge region, and the bow stop is spaced from an end of the bow support region.

12. The floating lift of claim 9, the bow stop comprising:
a changing port coupled to a charging power supply; and
a charging plug extending from the charging port.

13. The floating lift of claim 12, the bow stop comprising:
the bow stop including a first side, a second side opposite the first side, and a top side;
where the first side is configured to receive a bow of a watercraft; and
where the charging port is located on the top side or the second side.

14. The floating lift of claim 12, comprising:
a charging cable extending from the charging port, where the charging plug is located at an end of the charging cable.

15. The floating lift of claim 12, the bow stop comprising:
a retracting mechanism positioned in the bow stop and operably coupled to the charging cable, where the retracting mechanism operates to retract the charging cable to a location inside the bow stop when not in use.

16. The floating lift of claim 14, the bow stop comprising:
a control system configured to communicate with a system remote from the floating lift;
one more sensors located on the bow stop in communication with the control system, the one or more sensors including a first sensor, where when the first sensor receives a first sensed input it provides a first sensor output signal to the control system.

17. The floating lift of claim 16, the bow stop comprising:
an electric motor electrically coupled to the charging station; and
a winch coupled to the electric motor to operably aid in positioning a watercraft on the floating lift.

18. The floating lift of claim 16, comprising:
a battery system; and
a solar charging system coupled to the battery system, the solar charging system including solar panels positioned on a top surface of the lift body.

19. A floating lift comprising:
a float body including a first edge region, a second edge region, and a bow support region;
a bow stop located on the float body;
where the bow support region and the bow stop are located between the first edge region and the second edge region, and the bow stop is spaced from an end of the bow support region; and
a charging station located on the float body, spaced from the bow stop.

20. The floating lift of claim 19, comprising:
a mechanism positioned between the bow stop and the charging station, where the mechanism moves the bow stop relative to the charging station.
